(19) United States
(12) Patent Application Publication
(10) Pub. No.: US 2013/0227128 A1
(43) Pub. Date: Aug. 29, 2013

(54) Graphical Tools For Obtaining Data From A Medical Device

(71) Applicant: David Lloyd Wagstaff, Lake Forest, CA (US)

(72) Inventor: David Lloyd Wagstaff, Lake Forest, CA (US)

(73) Assignee: LANTRONIX, INC., Irvine, CA (US)

(21) Appl. No.: 13/821,526

(22) PCT Filed: Sep. 8, 2011
(86) PCT No.: PCT/US11/50880

§ 371 Date: Apr. 5, 2013

Related U.S. Application Data
(60) Provisional application No. 61/381,016, filed on Sep. 8, 2010.

(51) Int. Cl. H04L 12/26

(52) U.S. Cl. CPC H04L 43/045
USPC 709/224

(57) ABSTRACT

A system and method to allow for connectivity of a plurality of medical devices in a health care setting and the delivery of data from those medical devices to an individual to utilize the information received is provided. In typical medical devices, the reporting of data is distinct and hard to interpret. The present invention provides a set of graphical tools that allow the interpretation of different data from different medical devices. Additionally, the present invention provides a set of software tools that allows the data received from a plurality of different medical devices to be separated into more appropriate fields based on pre-determined configuration to assign specific flagged data to specific devices. This information allows the user to receive data whereby the data is previously interpreted to determine from what medical device the information has been received and how to interpret the data for further processing. The present invention also allows for interpreted data received from a plurality of medical devices to be sent to a health care information system department for further processing and analysis.

### CROSS REFERENCES TO RELATED APPLICATION

This application is related to and claims priority from PCT International Patent Application No. PCT/US2011/050880 filed Sep. 8, 2011, and U.S. Provisional Patent Application Ser. No. 61/381,016 filed Sep. 8, 2010.

### FIELD OF THE INVENTION

The present invention relates to managing healthcare related information and more particularly to providing graphical tools that enable processing and interpreting healthcare related information generated by medical devices.

### BACKGROUND

The number of network-connected devices has grown dramatically over the last decade. Such growth is expected to continue far into the future, causing enormous problems of integration for consumers, companies, and governments. One significant problem is the inclusion of many legacy devices that were never intended to be connected to a network. Further, many network enabled devices have inadequate monitoring and control capabilities. These problems are pervasive and may involve various types of equipments ranging from, for example, fax machines, printers, copiers and other office equipment, to specialized devices found in manufacturing plants, home appliances, hand-held electronics and medical devices. Some of these equipments may have network capability but may not be part of an integrated network. This problem is particularly acute for the administrators, who often find them spending a great deal of money and time bridging heterogeneous management systems. Some of these equipments may not contain state information and can be even more difficult to manage. A more homogeneous management environment can save time and money, but numerous vendors have many valid business and technical reasons for avoiding homogeneous management systems.

### SUMMARY OF THE INVENTION

Some embodiments of the invention employ a system and method to allow for connecting a plurality of medical devices in a health care setting and delivering data from those medical devices to a Hospital or Clinical Information System (H/CIT) to utilize the information received. Some embodiments of the invention provide a set of graphical tools that allow the interpretation of different data from different medical devices. Some embodiments of the invention provide a set of software tools that allows the data received from a plurality of different medical devices to be separated into more appropriate fields based on pre-determined configuration to assign specific flagged data to specific devices. This information allows the user to receive data whereby the data is previously interpreted to determine from what medical device the information has been received and how to interpret the data for further processing. Some embodiments of the invention allow for interpreted data received from a plurality of medical devices to be sent to a health care information system for further processing and analysis.

An exemplary embodiment of the present invention, it is contemplated that the system for collecting and interpreting data to be used in a hospital or clinical environment, the system comprising: a first set of medical devices configured to generate data in different formats; and a first device server coupled with the first set of medical devices and configured to include a data interpretation module to identify data associated with each medical device in the first set, interpret the data associated with each medical device in the first set, and identify type of data associated with each medical device in the first set, wherein the first device server is to transmit the interpreted data to a hospital or clinical information system (H/CIT).

In another exemplary embodiment, the first device server further includes a conduit manager configured to operate with one or more different communication protocols to accommodate communication protocols specific to each of the plurality of medical devices in the first set.

In another exemplary embodiment, the first device server is further configured to present a graphical user interface to present the interpreted data to a user.

In another exemplary embodiment, the plurality of medical devices in the first set are located within a healthcare facility.

In another exemplary embodiment, a device server manager coupled with the first device server and configured to receive management information from the first device server.

In another exemplary embodiment, the first device server is connected to a first network and the device server manager is connected to a second network.

In another exemplary embodiment, the device server manager is coupled to a second device server connected to a third network and to a second set of medical devices separate from the first set of medical devices connected to the first device server.

In another exemplary embodiment, the second device server is configured to receive data from the medical devices in the second set, generate interpreted data associated with the medical devices in the second set, and transmit that interpreted data to the H/CIT.

In another exemplary embodiment, the second network is a wide area network (WAN), and wherein communication between the device server manager and the first or the second device server is carried out using transmission control protocol/Internet (TCP/IP) protocol.

In another exemplary embodiment, the first and second device servers create their own connection to the device server manager by periodically authenticating themselves to the device server manager, and the connection is kept open for bi-directional communication.

In an exemplary embodiment, a computer implemented method for collecting and interpreting data from different medical devices, the method comprising: establishing a connection to each of a plurality of medical devices associated with a hospital network, wherein each of the medical devices is configured to generate data in a different format; receiving the data generated by each of the medical devices via the corresponding connection; interpreting the data of each of the medical devices to generated interpreted data; associated the interpreted data with their medical devices along with type of data; and transmitting the interpreted data along with information about the medical devices and type of data to a hospital or clinical information system (H/CIT).

In another exemplary embodiment, interpreting the data comprises separating the data into fields based on pre-determined configuration to assign specific flagged data to a specific medical device.

In another exemplary embodiment, generating a user interface to enable a user to view the interpreted data along with the information about the medical devices and type of data.

In another exemplary embodiment, transmitting the interpreted data along with the information about the medical devices and type of data to a department information system for analysis.

In another exemplary embodiment, establishing a connection with a device server manager for authentication.

In another exemplary embodiment, the device server manager is connected to a wide area network (WAN), and wherein the connection with the device server manager is based on transmission control protocol/Internet protocol (TCP/IP).

In another exemplary embodiment, establishing a connection with a remote system administrator station and to transmit management information to the system administrator station.

In an exemplary embodiment, a computer-readable media that stores instructions, which when executed by a machine, cause the machine to perform operations comprising: establishing a connection to each of a plurality of heterogeneous medical devices associated with a hospital network; receiving the data generated by each of the medical devices via the corresponding connection; interpreting the data of each of the medical devices to generated interpreted data; generating a user interface to enable a user to view the interpreted data; and transmitting the interpreted data to a hospital or clinical information system (H/CIT).

In another exemplary embodiment, associating the interpreted data with their medical devices along with type of data; transmitting the interpreted data along with the information about the medical devices and type of data to a department information system for analysis; and establishing a connection with a device server manager for authentication.

In another exemplary embodiment, each of the medical devices is configured to generate data in a different format, and wherein interpreting the data comprises of separating the data into fields based on pre-determined configuration to assign specific flagged data to a specific medical device.

### BRIEF DESCRIPTION OF THE DRAWING

The multiple drawings refer to the embodiments of the invention.

FIG. 1 is a block diagram illustrating an example device server configured with a device interpretation tool, in accordance with some embodiments.

FIG. 2 is a block diagram illustrating an example device server configured with a conduit manager, in accordance with some embodiments.

FIG. 3 is a block diagram illustrating an example device server configured to transmit device management information to a remote system administrator station, in accordance with some embodiments.

FIG. 4 is a block diagram illustrating an example of multiple device servers configured to communicate with a device server manager, in accordance with some embodiments.

FIG. 5A is a flow diagram illustrating an example process that may be performed by a device server, in accordance with some embodiments.

FIG. 5B is a flow diagram illustrating another example process that may be performed by a device server, in accordance with some embodiments.

FIG. 6 is a system diagram of an example computer system, in accordance with some embodiments.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DESCRIPTION

In the following description, numerous specific details are set forth, such as examples of specific voltages, named components, connections, types of circuits, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as a first device server, a second device server, etc. may be made. However, the specific numeric reference should not be interpreted as a literal sequential order but rather interpreted that the first device server is different than the second device server. Thus, the specific details set forth are merely exemplary. The specific details may be varied from and still be contemplated to be within the spirit and scope of the present invention.

### Overview

Device management functionality comes in many different forms depending on the administrator's needs and the capabilities of the target device. Common management functions include monitoring the device's critical information, taking an inventory of the devices sub-systems, logging interesting events that take place, sending alerts to an administrator, recovering the device if the power fails, ensuring the data is secure, asset tracking, or reporting information to an administrator. Administrators also employ more advanced management functions including scripting or programming, aggregating device data from multiple devices, diagnostics, taking action based on the device data content, trending device data, reporting information in a final format including a spreadsheet or graph, or translating from one management format to another. A major area of management functionality includes securing the device through providing confidentiality of data, data integrity, administrator authentication, device authentication, risk mitigation, countermeasures, or protection against hostile environments and threats.

As an example, various medical devices surrounding a patient's bed operate independently of each other and include non-standard wires, tubes, and interfaces. One problem is lack of integration between the medical devices. For example, some medical devices generate information in a proprietary format, which is not compatible with other medical devices from different vendors. In another example, a medical device may produce an analog signal for a patient's vital signs. Because the signal is not digital or recorded, the analog signal must be transcribed onto a piece of paper or else the information is lost. As a result of this lack of integration, health care professionals must pay greater attention to control and monitor many medical devices individually, requiring more personnel to transcribe the data, more time to review the data, and greater potential for lost data and transcription error. Some devices with analog signals may store the data for short periods of time but again, the time must be taken later to review and transcribe the information. Additionally, there is little to no integration between the plurality of medical devices.

### Device Server

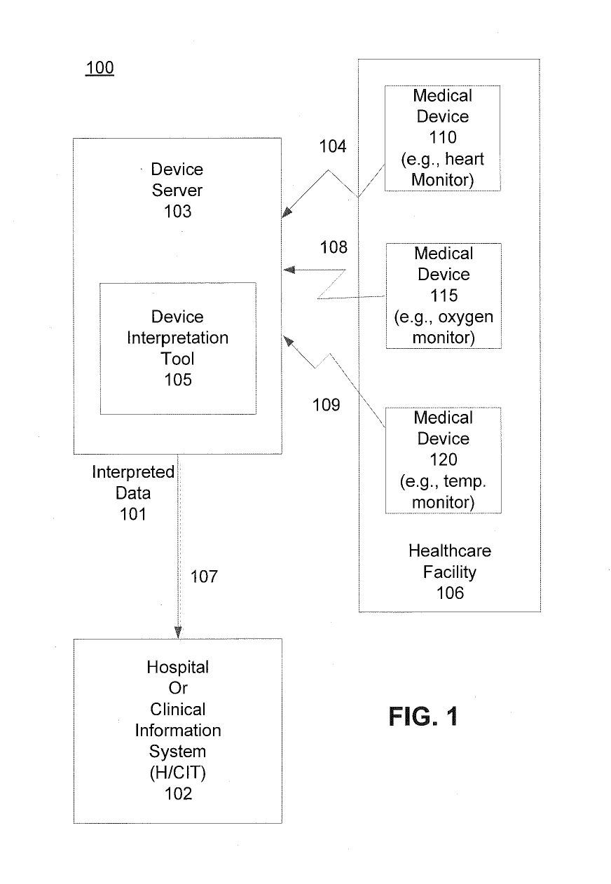

FIG. 1 is a block diagram illustrating an example device server configured with a device interpretation tool, in accordance with some embodiments. Diagram 100 includes a system that allows interpreting data from a plurality of different medical devices which transport different data information to an information technology system. Diagram 100 includes a plurality of medical devices including the medical devices 110, 115 and 120. These medical devices 110, 115 and 120 may be included in a hospital or a health care facility 106. For some embodiments, these medical devices 110, 115 and 120 may be different or heterogeneous such that they don't all conform to a certain standard in terms of how their data is formatted and interpreted and further in terms of how their data is viewed or presented to a user or to any other system. Diagram 100 also includes a device server 103 configured to communicate and receive information generated by the medical devices 110, 115 and 120. The medical devices 110, 115 and 120 may be located locally to the device server 103, or they may be located remotely from the device server 103. Each of the medical devices 110, 115 and 120 may use the communication link 104, 108 and 109 respectively to communicate with the device server 103.

For some embodiments, the device server 103 may include a device interpretation tool 105 configured to process and interpret the data received from the medical devices 110, 115 and 120. The device interpretation tool 105 may be implemented in hardware, software or a combination of both. The device interpretation tool 105 may generate interpreted data 101 for each of the medical devices 110, 115 and 120. Thus, the device server 103 may communicate, monitor, collect and interpret the data associated with the medical devices 110, 115 and 120. The interpreted data 101 may be transmitted to a user such as an administrator or a hospital or clinical information system (H/CIT) 102 using the communication link 107 for further processing.

For some embodiments, the device interpretation tool 105 may separate the interpreted data into appropriate fields corresponding to the medical devices that the data is associated with. For example, the device interpretation tool 105 may determine the type of medical device that sent the data and provide the data to a user in such a fashion that enables the user to clearly delineate the type of medically relevant information being viewed. For example, the user may be able to see heart related information generated by the medical device 110, oxygen related information from the medical device 115, and temperature related information from the medical device 120.

### Conduit Manager

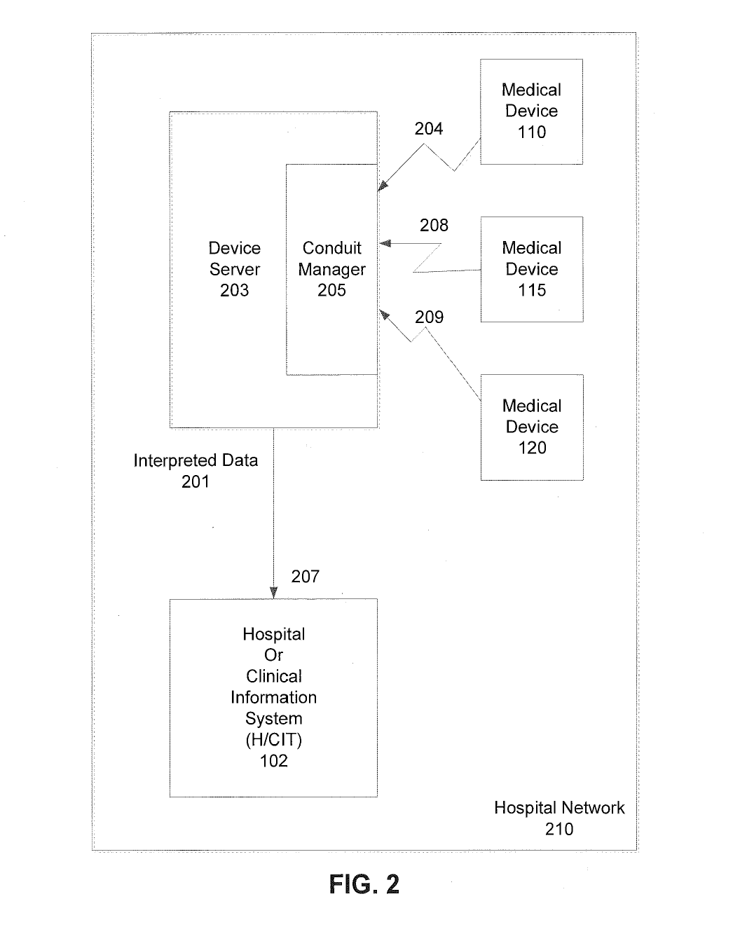

FIG. 2 is a block diagram illustrating an example device server configured with a conduit manager, in accordance with some embodiments. Device server 203 may include a conduit manager 205 to communicate with the medical devices 110, 115 and 120. The conduit manager 205 may operate with one or more different communication protocols (e.g., serial, parallel, universal serial bus (USB), transmission control protocol/Internet protocol (TCP/IP), etc.) to accommodate the communication protocol specific to each of the medical devices 110, 115 and 120 using the links 204, 298 and 209, respectively. The conduit manager may process the data received from the medical devices 110, 115 and 120 and pass that data to other logics included in the device server 203. The logics in the device server 203 may include the device interpretation tool 105 illustrated in FIG. 1. The interpreted data 201 generated by the device server 203 may then be transmitted to the H/CIT 102 using the communication link 207. As illustrated, the device server 203, the medical devices 110, 115 and 120 and the H/CIT 102 in this example may be part of a hospital network 210.

### System Administrator and Graphical Tools

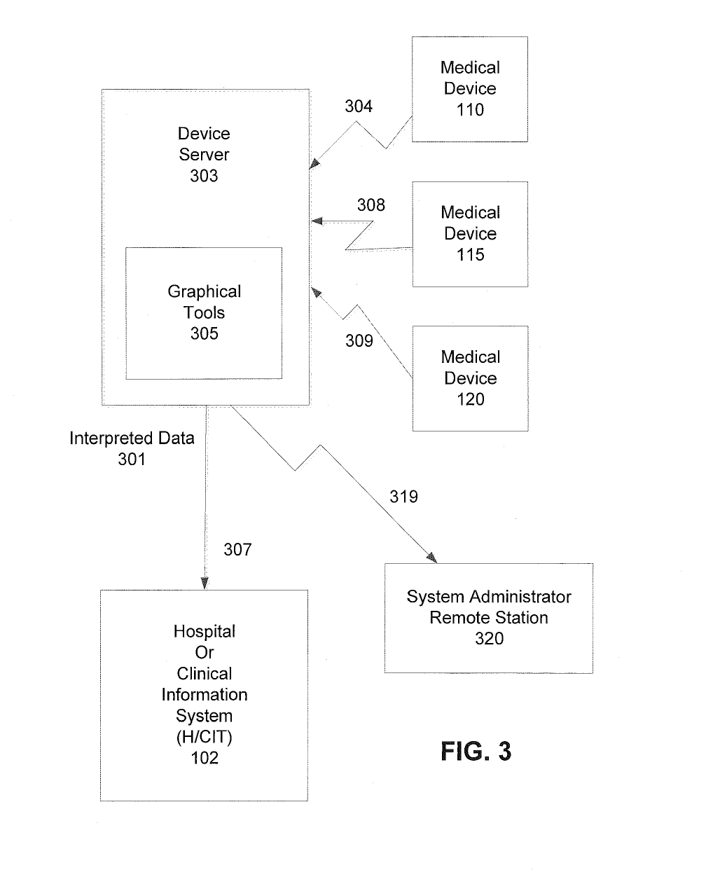

FIG. 3 is a block diagram illustrating an example device server configured to transmit device management information to a remote system administrator station, in accordance with some embodiments. Device server 303 may include logic such as the device interpretation tool 105 to interpret the data. Once the device server 303 identifies the type of medical device associated with the data, the device server 303 may then parse the information and present the data to the H/CIT 102 in a manner as to allow the user to select the medical device and the data associated with the medical device. For some embodiments, the device server 303 may further send the data to other information systems associated with various departments so that the data may be further processed, collected and stored for use by other users.

Device server 303 may include graphical tools 305 configured to graphically display the information received from the medical devices 110, 115 and 120. The graphical tools 305 may separate the data from the medical devices 110, 115 and 120 such that a user can identify the information received as relating to a specific type of medical device and can understand the data received from that medical device. The graphical tools 305 may be configured to generate and present a user interface to allow the user to view and manipulate the data received from the medical devices 110, 115 and 120. The user interface may include options to select the type of medical device, the type of information among others. For example, there may be a pull-down menu to display options to select heart information, oxygen information or temperature information. There may be another pull-down menu to display options to select a heart monitoring medical device, an oxygen monitoring medical device, or a temperature monitoring medical device. The user interface may make it easier for the user to understand the data received from the medical devices and may allow the user to perform further analysis using graphical tools or any other tools that may be available using the menus of the user interface.

For some embodiments, the device server 303 may be communicatively coupled with a system administrator station located remotely using the communication link 307. This may enable an administrator to monitor the status of the medical devices as well as the communication link established between the device server 303 and the medical devices 110, 115 and 120. The administrator may receive error messages, device data and other information for analysis and review.

### Device Server Manager and Networks of Device Servers

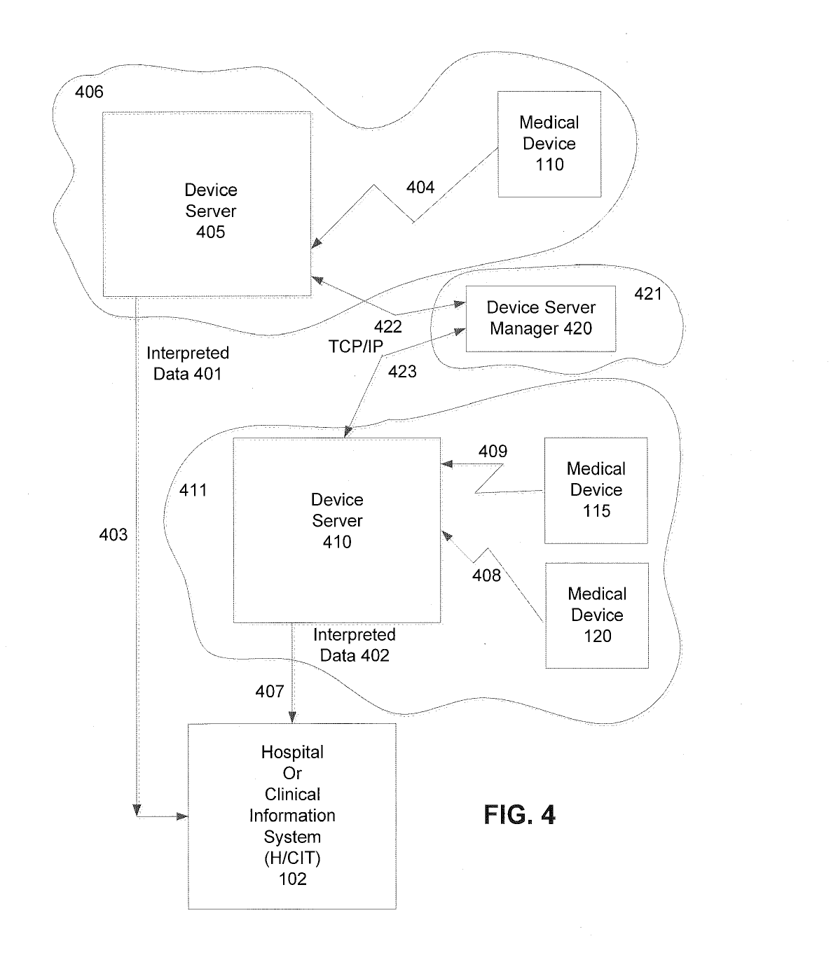

FIG. 4 is a block diagram illustrating an example of multiple device servers configured to communicate with a device server manager, in accordance with some embodiments. There may be multiple device servers connected to different networks. For example, device server 405 may be connected to the network 406 and the device server 410 may be connected to the network 411. The medical device 110 may be communicatively connected to the device server 405 using the link 404. The medical devices 115 and 120 may be communicatively connected to the device server 410 using the links 408 and 409, respectively. Each of the device servers 405 and 410 may include logic to interpret the data received from their respected connected medical devices, and each may independently transmit its interpreted data 401 or 402 to the H/CIT 102 using the respective link 403 or 407.

For some embodiments, a device server manager 420 may be used to manage the device servers 405 and 410. The device server manager 420 may be connected to the network 421 but separated from the networks 406 and 411. For some embodiments, the network 421 may be a wide area network (WAN) and the networks 406 and 411 may be private networks. The device server manager 420 may use TCP/IP links 422 and 423 to communicate with the device servers 405 and 410. Both the device server 405 and the device server 410 may create their own direct communication tunnel to the device server manager 420 by periodically authenticating themselves to the device server manager 420 and establishing an outgoing TCP/IP connection to the device server manager 420. The TCP/IP connection may be kept open for future bi-directional communication.

### Flow Diagrams

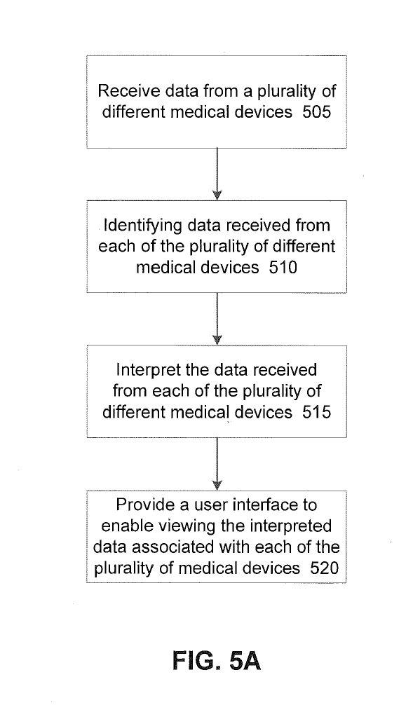

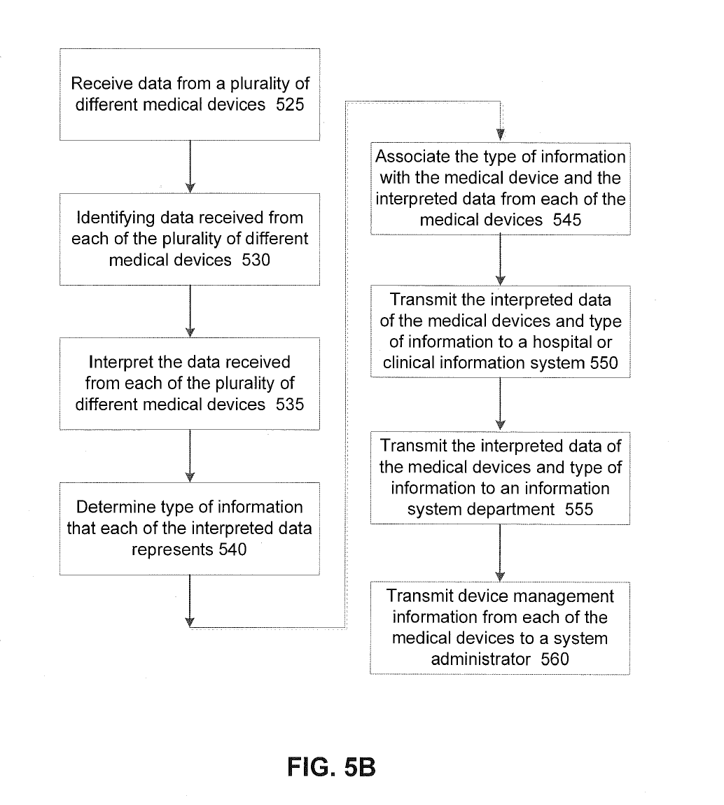

FIG. 5A is a flow diagram illustrating an example process that may be performed by a device server, in accordance with some embodiments. At block 505, the data from the medical devices is received by the device server. The medical devices may be heterogeneous such that their data may be formatted differently. At block 510, the device server may identify the data received and associate the medical device to the data received. At block 515, the device server may interpret the data received from the medical devices. This may include transforming the data into a data format that can be understood by a user. This may, for example, format the data using graphical tools. At block 520, the data is presented to a user using a user interface. The user may use pull down menus associated with the user interface to selectively view the data from the various medical devices.

FIG. 5B is a flow diagram illustrating another example process that may be performed by a device server, in accordance with some embodiments. At block 525, the data from the medical devices is received by the device server. At block 530, the device server may identify the data received and associate the medical device to the data received. At block 535, the device server may interpret the data received from the medical devices. At block 540, the device server may determine the type of information that each of the interpreted data represents. For example, the data from the medical device 110 represents heart information, etc. At block 545, the device server may associate the type of information with the medical device and the corresponding interpreted data. At block 550, the information generated from the block 545 is transmitted to a H/CIT 102. The same information may also be transmitted to department information systems, as shown in block 555. At block 560, the device server may send management information to a system administrator. The management information may include error messages, and status information from the medical devices, etc.

### Computer System

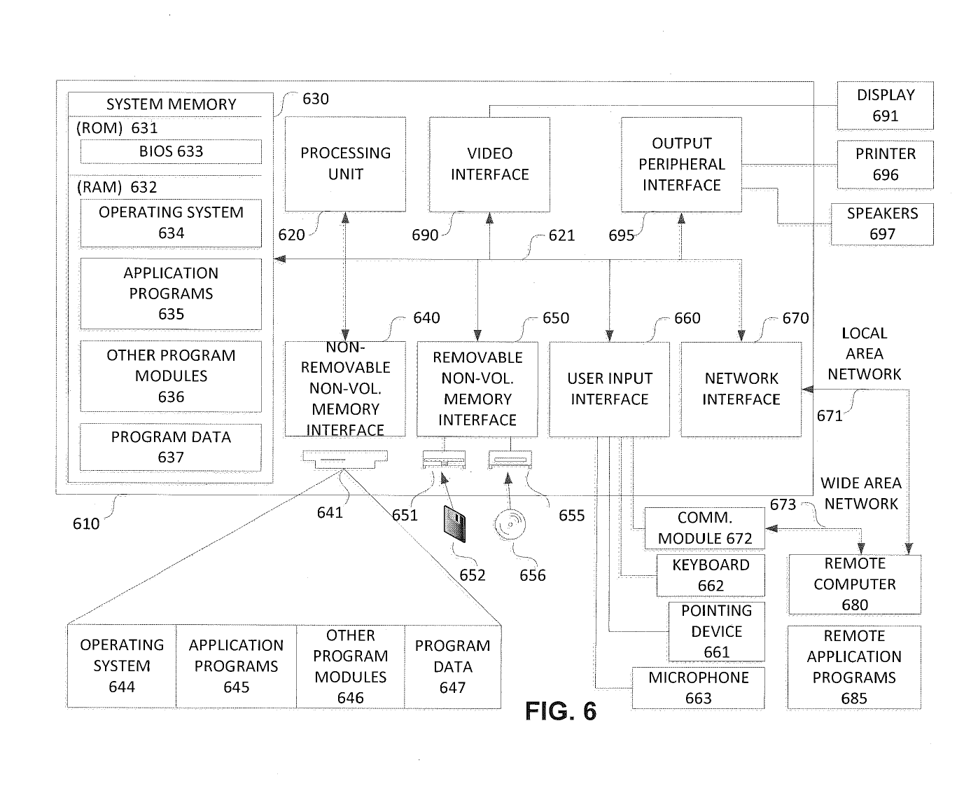

FIG. 6 is a system diagram of an example computer system, in accordance with some embodiments. Computing device 610 may be used to implement a device server, a device server manager or any computing device associated with embodiments of the present invention. The computing device 610 may be a general-purpose computing device and may include, but are not limited to, a processing unit 620 having one or more processing cores, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing device 610 typically includes a variety of computing machine readable media. Computing machine-readable media can be any available media that can be accessed by computing device 610 and includes both volatile and nonvolatile media, removable and non-removable media. By way of example, and not limitation, computing machine-readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 610. Communication media typically embodies computer readable instructions, data structures, program modules, or other transport mechanisms and includes any information delivery media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computing device 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computing device 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computing device 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies

A user may enter commands and information into the computing device 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but they may be connected by other interface and bus structures, such as a parallel port, game port or a universal serial bus (USB). A monitor or display 691 or other type of display device is also connected to the system bus 621 via an interface, such as a video interface 690. In addition to the monitor, computers may also include other peripheral output devices such as speakers 697 and printer 696, which may be connected through an output peripheral interface 690.

The computing device 610 may operate in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computing device 610. The logical connections depicted in FIG. 6 include a local area network (LAN) 671 and a wide area network (WAN) 673, but may also include other networks. Such networking environments are common in offices, enterprise-wide computer networks, intranets and the Internet. A browser application may be resident on the computing device and stored in the memory.

When used in a LAN networking environment, the computing device 610 is connected to the LAN 671 through a network interface or adapter 670. When used in a WAN networking environment, the computing device 610 typically includes a communication module 672 or other means for establishing communications over the WAN 673, such as the Internet. The communication module 672 may be a modem used for wired, wireless communication or both. The communication module 672 may be internal or external, may be connected to the system bus 621 via the user-input interface 660, or other appropriate mechanism. In a networked environment, program modules depicted relative to the computing device 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

It should be noted that the present design can be carried out on a computing system such as that described with respect to FIG. 6. However, the present design can be carried out on a server, a computer devoted to message handling, or on a distributed system in which different portions of the present design are carried out on different parts of the distributed computing system.

Another device that may be coupled to bus 611 is a power supply such as a battery and alternating current (AC) adapter circuit. As discussed above, the DC power supply may be a battery, a fuel cell, or similar DC power source that needs to be recharged on a periodic basis. For wireless communication, the communication module 672 may employ a Wireless Application Protocol to establish a wireless communication channel. The communication module 672 may implement a wireless networking standard such as Institute of Electrical and Electronics Engineers (IEEE) 802.11 standard, IEEE std. 802.11-1999, published by IEEE in 1999.

Although the foregoing embodiments have been described in some detail for purposes of clarity of understanding, the invention is not limited to the details provided. Functionality of logic blocks may be implemented in software, hardware, active components and/or combinations thereof. There are many alternative ways of implementing the invention using the techniques described. The disclosed embodiments are illustrative and not restrictive.

What is claimed is:

1. A system for collecting and interpreting data to be used in a hospital or clinical environment, the system comprising:
a first set of medical devices configured to generate data in different formats; and
a first device server coupled with the first set of medical devices, and comprising a data interpretation module configured to identify data associated with each medical device in the first set, interpret the data associated with each medical device in the first set, and identify type of data associated with each medical device in the first set, and comprising graphical tools configured to generate a user interface allowing a user to manipulate interpreted data according to type of medical device, wherein the first device server is further configured to transmit the user interface and interpreted data to a hospital or clinical information system (H/CIT).

2. The system of claim 1, wherein the first device server further includes a conduit manager configured to operate with one or more different communication protocols to accommodate communication protocols specific to each of the plurality of medical devices in the first set.

3. The system of claim 1, wherein the first device server is further configured to present the graphical user interface to present the interpreted data to a user.

4. The system of claim 1, wherein the plurality of medical devices in the first set are located within a healthcare facility.

5. The system of claim 1, further comprising a device server manager coupled with the first device server and configured to receive management information from the first device server.

6. The system of claim 5, wherein the first device server is connected to a first network and the device server manager is connected to a second network.

7. The system of claim 5, wherein the device server manager is coupled to a second device server connected to a third network and to a second set of medical devices separate from the first set of medical devices connected to the first device server.

8. The system of claim 7, wherein the second device server is configured to receive data from the medical devices in the second set, generate interpreted data associated with the medical devices in the second set, and transmit that interpreted data to the H/CIT.

9. The system of claim 7, wherein the second network is a wide area network (WAN), and wherein communication between the device server manager and the first or the second device server is carried out using transmission control protocol/Internet (TCP/IP) protocol.

10. The system of claim 9, wherein the first and second device servers create their own connection to the device server manager by periodically authenticating themselves to the device server manager, and the connection is kept open for bi-directional communication.

11. A computer implemented method for collecting and interpreting data from different medical devices, the method comprising:
establishing a connection to each of a plurality of medical devices associated with a hospital network, wherein each of the medical devices is configured to generate data in a different format;
receiving the data generated by each of the medical devices via the corresponding connection;
interpreting the data of each of the medical devices to generated interpreted data;
associated the interpreted data with their medical devices along with type of data;
generating a user interface via graphic tools within a device server, the user interface allowing a user to manipulate the interpreted data according to type of data; and
transmitting the user interface and interpreted data along with information about the medical devices and type of data to a hospital or clinical information system (H/CIT).

12. The system of claim 11, wherein interpreting the data comprises separating the data into fields based on pre-determined configuration to assign specific flagged data to a specific medical device.

13. The method of claim 11, further comprising of remotely generating the user interface to enable a user to view the interpreted data along with the information about the medical devices and type of data.

14. The method of claim 13, further comprising of transmitting the interpreted data along with the information about the medical devices and type of data to a department information system for analysis.

15. The method of claim 13, further comprising of establishing a connection with a device server manager for authentication.

16. The method of claim 15, wherein the device server manager is connected to a wide area network (WAN), and wherein the connection with the device server manager is based on transmission control protocol/Internet protocol (TCP/IP).

17. The method of 16, further comprising of establishing a connection with a remote system administrator station and to transmit management information to the system administrator station.

18. A computer-readable media that stores instructions, which when executed by a machine, cause the machine to perform operations comprising:
establishing a connection to each of a plurality of heterogeneous medical devices associated with a hospital network;
receiving the data generated by each of the medical devices via the corresponding connection;
interpreting the data of each of the medical devices to generated interpreted data;
generating a user interface via graphic tools within a device server to enable a user to view and manipulate the interpreted data, the user interface representing the heterogeneous medical devices; and
transmitting the user interface and interpreted data to a hospital or clinical information system (H/CIT).

19. The computer-readable medium of claim 18, further comprising:
associating the interpreted data with their medical devices along with type of data;
transmitting the interpreted data along with the information about the medical devices and type of data to a department information system for analysis; and
establishing a connection with a device server manager for authentication.

20. The computer-readable medium of claim 19, wherein each of the medical devices is configured to generate data in a different format, and wherein interpreting the data comprises of separating the data into fields based on pre-determined configuration to assign specific flagged data to a specific medical device.
